(19) United States
(12) Patent Application Publication
(10) Pub. No.: US 2012/0102533 A1
(43) Pub. Date: Apr. 26, 2012

(54) REMOTE-CONTROLLER TYPE TELEPHONE SERVICE SYSTEM IN SET-TOP BOX OF INTERNET TELEVISION HAVING VIDEO SOLUTION

(75) Inventor: Heung Soo Park, Namyangju-si (KR)

(73) Assignee: HANWHA SOLUTION & CONSULTING CO., LTD., Seoul (KR)

(21) Appl. No.: 12/944,779

(22) Filed: Nov. 12, 2010

(30) Foreign Application Priority Data
Oct. 25, 2010 (KR) 10-2010-0104177

(51) Int. Cl. H04N 7/173

(52) U.S. Cl. 725/106; 348/14.03

(57) ABSTRACT

A remote-controller type telephone service system in a set-top box of an Internet television having a video solution is provided. In a telephone service system for providing a telephone function in an open platform based set-top box for providing an Internet television (web connected TV) function, the system includes a remote-controller type telephone terminal to provide a remote-controller function for the set-top box and a handset function for the telephone function. The set-top box includes a video telephone control unit to provide a video telephone function of displaying an image related to a video telephone on a screen of a TV based on a remote-controller signal when power of the TV is in an on-state; and an IP telephone control unit to provide an audio telephone function of outputting a voice related to an audio telephone when the power of the TV is in an off-state.

### CROSS-REFERENCE TO RELATED APPLICATION

This application claims priority to Korean Patent Application No. 10-2010-0104177, filed on Oct. 25, 2010 in the Korean Intellectual Property Office, the disclosure of which is expressly incorporated herein by reference in its entirety.

### BACKGROUND

1. Field of the Invention

The present invention relates to a set-top box of an Internet television having a video solution and a remote-controller type telephone service system in which a telephone function is additionally provided to a remote controller of the set-top box.

2. Description of the Related Art

Recently, technologies have been developed in which various information are transmitted/received through integrated heterogeneous media such as TVs, telephones, and computers. For example, a personal computer television (PCTV) that is a combination of a TV and a computer may provide a function of displaying a TV window on a computer screen together with a PC function.

As such a result, users at home transmit/receive various information using a web video phone in which the Internet is accessed with a telephone, and uses an Internet TV having an Internet mode for performing Internet functions and a TV mode for performing unique TV functions.

The Internet TV is implemented using a method of using a TV connected to a low-priced dedicated terminal for connecting to the Internet, a method of using a TV connected to a set-top box accessible to a modem on the Internet, and the like.

In the Internet TV using a set-top box connected to a TV as the technology for integrating various media is changed, interest in a remote-controller type telephone capable of remotely controlling a set-top box and a TV has been increased as well as a set-top box having telephone functions.

### SUMMARY

An aspect of the present invention provides a remote-controller type telephone service system in which a video telephone function and an audio telephone function are provided to a set-top box of an Internet TV, and a handset function corresponding to voice parts of video and audio telephones is provided to a remote controller of the set-top box.

According to an aspect of the present invention, there is provided a telephone service system for providing a telephone function in an open platform based set-top box for providing an Internet TV (web connected TV) function, the system including a remote-controller type telephone terminal to provide a remote-controller function for the set-top box and a handset function for the telephone function, wherein the set-top box includes a video telephone control unit to provide a video telephone function of displaying an image related to a video telephone on a screen of a TV based on a remote-controller signal from the remote-controller type telephone terminal and outputting a voice related to the video telephone through the handset function of the remote-controller type telephone terminal, when power of the TV is in an on-state; and an IP telephone control unit to provide an audio telephone function of outputting a voice related to an audio telephone through the handset function of the remote-controller type telephone terminal using an IP network based on a remote-controller signal from the remote-controller telephone terminal, when the power of the TV is in an off-state.

The video telephone control unit may provide a virtual key pad for inputting a telephone number on the screen of the TV.

The video telephone control unit may provide at least one of a multi-party video telephone function and zoom-in, zoom-out and movement functions for the image.

The remote-controller type telephone terminal may include a signal detecting unit to detect an on/off-state of the power of the TV; a video telephone processing unit to process voice transmission/reception for the video telephone in conjunction with the video telephone control unit when the power of the TV is in an on-state; and an IP telephone processing unit to process voice transmission/reception for the audio telephone in conjunction with the IP telephone control unit when the power of the TV is in an off-state.

The remote-controller type telephone terminal may further include a key pad processing unit to activate a remote-controller key related to the video telephone function when the power of the TV is in an on-state and to activate a remote-controller key related to the audio telephone function when the power of the TV is in an off-state; and a remote-controller control unit to provide the remote-controller key inputted through the key pad processing unit as a key signal recognizable in the set-top box, corresponding to the on/off-state of the power of the TV. When the remote-controller key related to the video telephone function and the remote-controller key related to the audio telephone function are in a non-activation state, the key pad processing unit may activate a remote-controller key related to the Internet TV. The key pad processing unit may provide at least one of a zoom-in key for enlarging the image, a zoom-out key for reducing the image and a movement key for moving the image, corresponding to the video phone function.

As described above, according to embodiments of the present invention, a video/audio telephone function is additionally provided to a remote controller of a set-top box for supporting an Internet TV function, so that it is possible to control an Internet TV using only the remote controller and to use a video/audio telephone, thereby enhancing a user's convenience and simplifying a configuration of media separately used.

Also, even in a case where the set-top box of the Internet TV is turned off, the set-top box may be used as an Internet telephone using an IP network for supporting the Internet TV function, thereby enhancing the performance of the telephone function provided to the set-top box.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a set-top box and a remote-controller type telephone terminal, which constitute a remote-controller type telephone service system according to an embodiment of the present invention; and

FIG. 2 is a block diagram illustrating a configuration of a remote-controller type telephone service system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

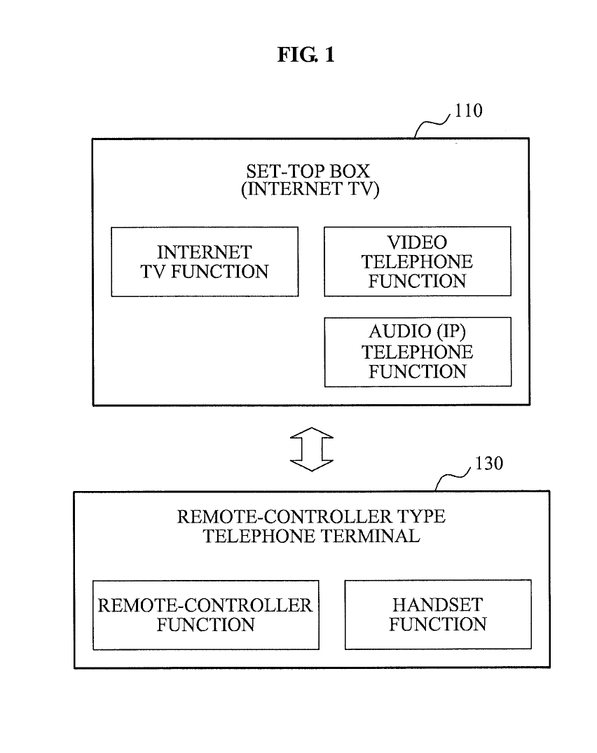

FIG. 1 is a diagram illustrating a set-top box and a remote-controller type telephone terminal, which constitute a remote-controller type telephone service system according to an embodiment of the present invention.

In the remote-controller type telephone service system according to the present exemplary embodiment, a set-top box 110 of an Internet TV may be provided with a video telephone function, and may be additionally provided with an IP-based audio telephone function so that when the set-top box 110 is turned off, the set-top box 110 may still be used as an Internet telephone. Here, the set-top box 110 may be configured separately from the Internet TV or integrally configured with the Internet TV. The set-top box 110 may correspond to a smart cross media open platform (SXMP)-based set-top box and may be different from a closed IPTV.

Thus, the set-top box 110 may provide an Internet TV function of receiving broadcasting signals from an IP network and reproducing the broadcasting signals through the Internet TV, and a video telephone function of transmitting/receiving video signals through a video communication line and an audio telephone function of transmitting/receiving voices via the IP network.

In the remote controller type telephone service system according to the present exemplary embodiment, a remote-controller type telephone terminal 130 (hereinafter, referred to as a ‘remote controller’), which is a remote control device of the set-top box 110, may be provided with a handset function corresponding to voice parts of video and audio telephones.

That is, the remote controller 130 may provide an integrated remote-controller function for the Internet TV and the set-top box, and may provide a voice transmitting function for a transmitted voice part and a voice receiving function for a received voice part in the video and audio telephone functions.

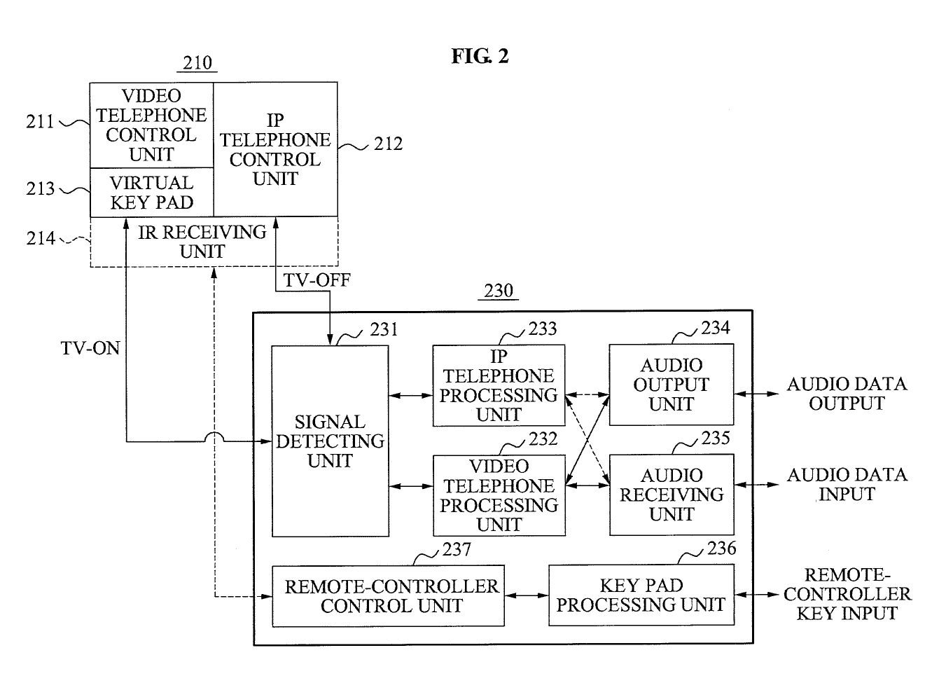

Hereinafter, a configuration of a set-top box and a remote controller, which constitute a remote-controller type telephone service system, will be described with reference to FIG. 2.

FIG. 2 is a block diagram illustrating the detailed configuration of a remote-controller type telephone service system according to an embodiment of the present invention.

First, as illustrated in FIG. 2, the set-top box 210 may include a video telephone control unit 211, an IP telephone control unit 212 and an IR receiving unit 214.

The video telephone control unit 211 may be provided with general dedicated hardware and program for the video telephone function, and may include a virtual key pad 213 used for the video telephone. In a case where the power of the TV is in an on-state, the virtual key pad 213 may be displayed on a screen of the TV so as to serve as a telephone directory used for the video telephone. That is, when a video telephone call is made through the set-top box 210, a telephone number may be inputted using the virtual key pad 213. When a video phone call is received while a user is watching the TV, the video telephone control unit 211 may display the video phone call on the screen of TV. In a case where the user accepts the video phone call, the video telephone control unit 211 may display an image of the video telephone on the screen of the TV and output the voice part of the video telephone through the handset function of a remote controller 230. The video telephone control unit 211 may provide a video solution enabling a multi-party video telephone call. In a case where the user accepts the multi-party video telephone call of the video telephone, an image may be divided on the screen of the TV so that images of the user and the other party may be displayed on the screen of the TV. The video solution of the video telephone control unit 211 may provide a zoom-in function of enlarging an image of the video telephone, displayed on the screen of the TV, a zoom-out function of reducing the image, and a movement function of moving the image on the screen of the TV.

The IP telephone control unit 212 may be provided with general dedicated hardware and a program for the Internet telephone function that may be in the form of an audio telephone. The IP telephone control unit 212 may be manufactured by providing the function of a general IP telephone terminal body to the set-top box 210. In this instance, the IP telephone control unit 212 may transmit/receive voice data via the IP network for supporting the Internet TV function so that a telephone call may be made even when the power of the TV is in an off-state. When an audio telephone call is received in the state that the power of the TV is on, the IP telephone control unit 212 may display the audio telephone call in the form of an alarm on the screen of the TV. Similarly, in a case where a user makes a telephone call or accepts a received telephone call, the IP telephone control unit 212 may output telephone voice through the handset function of the remote controller 230.

The IR receiving unit 214 functions to receive a remote-controller signal for controlling the Internet TV function and a remote-controller signal for the video telephone control unit 211 and the IP telephone control unit 212. In this instance, the IR receiving unit 214 may receive remote-control signals using an IR communication scheme. However, the IR receiving unit 214 may be replaced by a receiving device that receives remote-controller signals using various short-range communication schemes such as an RF communication scheme. The IR receiving unit 214 may receive a key signal corresponding to a key pad input of the remote controller 230 and then may determine whether the received key signal is a key signal related to the IP telephone or a key signal related to the video telephone, thereby providing the key signal to corresponding program. When the video solution is activated, the IR receiving unit 214 may receive key signals for zoom-in, zoom-out left/right control functions of a camera built into the Internet TV.

Next, as illustrated in FIG. 2, the remote controller 230 may include a signal detecting unit 231, a video telephone processing unit 232, an IP telephone processing unit 233, an audio output unit 234, an audio receiving unit 235, a key pad processing unit 236 and a remote-controller control unit 237.

The signal detecting unit 231 may monitor on/off states of the TV. In this instance, the signal detecting unit 231 may detect whether the power of the TV is in an on-state or in an off-state through communication with the set-top box 210. The signal detecting unit 231 may determine switching for the video telephone processing unit 232 or the IP telephone processing unit 233 based on the presence of activation of the video telephone control unit 211 or the IP telephone control unit 212.

If the signal detecting unit 231 determines that the power of the TV is in an on-state or in an off-state, the video telephone processing unit 232 processes transmission/reception of the voice part for the video telephone in conjunction with the video telephone control unit 211. In a case where a user intends to make a video telephone call, the video telephone processing unit 232 may receive a key input for a telephone number from the user and then provide it to the video telephone control unit 211.

In the case the signal detecting unit 231 determines that the power of the TV is in an off-state or that the IP telephone control unit 212 is in an activation state, the IP telephone processing unit 233 may process transmission/reception of telephone voices in conjunction with the IP telephone control unit 212. Similarly, in a case where a user intends to make an audio telephone call, the IP telephone processing unit 233 may receive a key input for a telephone number from the user and then provide it to the IP telephone control unit 212.

The audio output unit 234 may convert voices received through the video or IP telephone using a digital-to-analog conversion method and then output the converted voices.

After the audio receiving unit 235 receives voices inputted by a user, the audio receiving unit 235 may convert the received voices using the digital-to-analog conversion method and then provide the converted voices to the video telephone processing unit 232 or the IP telephone processing unit 233.

The remote-controller control unit 237 may provide various remote-controller keys inputted through the key pad processing unit 236 as a key signal in an infrared ray (IR) form, and the like, recognizable in the set-top box 210 based on the on/off-state of the power of the TV.

The key pad processing unit 236 may provide a key pad configured as various key buttons related to the Internet TV function, the video telephone function and the audio telephone function. In this instance, the key pad may include a key button for activating the video telephone function and a key button for activating the audio telephone function. The key pad may also include a zoom-in key for enlarging an image of the video telephone, a zoom-out key for reducing the image and a movement key for moving the image, corresponding to the video solution provided by the video telephone control unit 211. In the case the video and audio telephone functions are all in a non-activation state, the key pad processing unit 236 may be operated as a simple remote controller used only for the TV. In the case the power of the TV is in an on-state, the key pad processing unit 236 may activate a remote-controller key related to the video telephone function. In this instance, the remote controller 230 may enter a state valid for the video telephone, and provide the state to the set-top box 210 through the remote controller control unit 237. Accordingly, the video telephone control unit 211 may control the virtual key pad 213 to be displayed on the screen of the TV so as to wait for a user's input of a telephone number. When the telephone number is inputted by the user, the video telephone control unit 211 may display the inputted telephone number on the screen of the TV and attempts a video telephone connection to a video telephone having the corresponding telephone number. In the case the power of the TV is in an off-state, the key pad processing unit 236 may activate a remote-controller key related to the audio telephone function. In this instance, the remote controller 230 enters a state valid for the IP telephone so as to wait for a user's input of a telephone number. When the telephone number is inputted by the user, the remote controller may provide a signal related to the telephone number to the IP telephone control unit 212 through the remote-controller control unit 237. The key pad processing unit 236 may provide an image of the user and a zoom-in key for enlarging a remote image of the other party, a zoom-out key for reducing the image, and a movement key for moving the image.

According to the aforementioned configuration, in a case where the power of the TV is in an on-state, the remote-controller type telephone service system according to the present exemplary embodiment may provide a state valid for the video telephone by activating the configuration related to the video telephone function. In a case where the power of the TV is in an off-state, the remote-controller type telephone service system may provide a state available for the audio telephone by activating the configuration related to the IP-based audio telephone function. It will be apparent that in a case where the power of the TV is in an on-state, the remote-controller type telephone service system may also provide the IP-based audio telephone function based on a user's request.

Specifically, when a user requests video telephone connection, the set-top box 210 may perform the virtual key pad 213 on the screen of the TV and wait for a user's input of a telephone number in the state that the video telephone control unit 211 is activated and where the power of the TV is in an on-state. Subsequently, when the telephone number is inputted by the user, the set-top box 210 may attempt a video telephone connection to a video telephone having the corresponding telephone number. In the case the video telephone connection is performed, the set-top box 210 may display a video part of the video telephone on the screen of the TV and output a voice part of the video telephone through the handset function provided by the video telephone processing unit 232 of the remote controller 230. Also, when a video telephone call is received from an outside, the set-top box 210 may activate the video telephone control unit 211 and display the received video telephone call on the screen of the TV. In a case where the user accepts the video telephone call, the set-top box 210 may display an image of the video telephone on the screen of the TV and output a voice part of the video telephone through the handset function of the remote controller 230. In a case where a video camera is built in the set-top box 210, the user may remotely control the other party's camera and its own camera to perform zoom-in, zoom-out, left/right movement functions and the like, using the remote controller 230.

In a case where the user requests audio telephone connection, the set-top box 210 may wait for a user's input of a telephone number in the state that the IP telephone control unit 212 is activated. Subsequently, the set-top box 210 may receive the telephone number inputted from the remote controller 230 and then attempt the audio telephone connection for the received telephone number. In the case the audio telephone connection is performed, the set-top box 210 may output a voice part of the audio telephone through the handset function provided by the IP telephone processing unit 233 of the remote controller 230. Also, when an audio telephone call is received from an outside, the set-top box 210 may activate the IP telephone control unit 212. In a case where the user accepts the audio telephone call, the set-top box 210 may output the voice part of the audio telephone through the handset function of the remote controller 230.

As described above, according to embodiments of the present invention, a video/audio telephone function may be additionally provided to a remote controller of a set-top box for supporting an Internet TV function, to enable a control of an Internet TV and a video/audio telephone call using only the remote controller, thereby enhancing user's convenience and simplifying a configuration through a combination of various types of media.

Also, a video telephone function through the remote controller may be supported by providing a video telephone function to the set-top box of the Internet TV, and an Internet telephone function may be supported so that the voice telephone is available even when the set-top box is turned off, thereby enhancing the performance of the telephone function provided to the set-top box.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A telephone service system for providing a telephone function in an open platform based set-top box for providing an Internet TV (web connected TV) function, the system comprising a remote-controller type telephone terminal to provide a remote-controller function for the set-top box and a handset function for the telephone function,
wherein the set-top box comprises:
a video telephone control unit to provide a video telephone function of displaying an image related to a video telephone on a screen of a TV based on a remote-controller signal from the remote-controller type telephone terminal and outputting a voice related to the video telephone through the handset function of the remote-controller type telephone terminal, when power of the TV is in an on-state; and
an IP telephone control unit to provide an audio telephone function of outputting a voice related to an audio telephone through the handset function of the remote-controller type telephone terminal using an IP network based on a remote-controller signal from the remote-controller telephone terminal, when the power of the TV is in an off-state.

2. The system of claim 1, wherein the video telephone control unit provides a virtual key pad for inputting a telephone number on the screen of the TV.

3. The system of claim 1, wherein the video telephone control unit provides at least one of a multi-party video telephone function and zoom-in, zoom-out and movement functions for the image.

4. The system of claim 1, wherein the remote-controller type telephone terminal comprises:
a signal detecting unit to detect an on/off-state of the power of the TV;
a video telephone processing unit to process voice transmission/reception for the video telephone in conjunction with the video telephone control unit when the power of the TV is in an on-state; and
an IP telephone processing unit to process voice transmission/reception for the audio telephone in conjunction with the IP telephone control unit when the power of the TV is in an off-state.

5. The system of claim 4, wherein the remote-controller type telephone terminal further comprises:
a key pad processing unit to activate a remote-controller key related to the video telephone function when the power of the TV is in an on-state and to activate a remote-controller key related to the audio telephone function when the power of the TV is in an off-state; and
a remote-controller control unit to provide the remote-controller key inputted through the key pad processing unit as a key signal recognizable in the set-top box, corresponding to the on/off-state of the power of the TV,
wherein the key pad processing unit activates a remote-controller key related to the Internet TV when the remote-controller key related to the video telephone function and the remote-controller key related to the audio telephone function are in a non-activation state, and provides at least one of a zoom-in key for enlarging the image, a zoom-out key for reducing the image and a movement key for moving the image, corresponding to the video phone function.
